(19) United States
(12) Patent Application Publication
(10) Pub. No.: US 2025/0234229 A1
(43) Pub. Date: Jul. 17, 2025

(54) MEASUREMENT GAP

(71) Applicant: QUALCOMM Incorporated, San Diego, CA (US)

(72) Inventors: Bapineedu Chowdary GUMMADI, Hyderabad (IN); Sidhanta Ranjan SAHU, Hyderabad (IN); Kishore DANTA, Hyderabad (IN)

(21) Appl. No.: 18/415,571

(22) Filed: Jan. 17, 2024

(51) Int. Cl. H04W 24/10; H04B 7/06; H04W 8/22; H04W 84/06

(52) U.S. Cl. CPC H04W 24/10; H04B 7/0632; H04W 8/22; H04W 84/06

(57) ABSTRACT

Apparatus, methods, and computer program products for wireless communication are provided. An example method may include receiving, from a network entity, a configuration of at least one measurement associated with a gap length, a gap periodicity, and a gap offset. The example method may further include transmitting, to the network entity, UAI including a request for a first value for the gap length, a second value for the gap periodicity, or a third value for the gap offset. The example method may further include receiving, from the network entity, an indication associated with the first value for the gap length, the second value for the gap periodicity, or the third value for the gap offset. The example method may further include performing the at least one measurement.

### TECHNICAL FIELD

The present disclosure relates generally to communication systems, and more particularly, to wireless communication systems with measurement gap configured for a user equipment (UE).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a user equipment (UE) are provided. The apparatus may include at least one memory and at least one processor coupled to the at least one memory. Based at least in part on information stored in the at least one memory, the at least one processor, individually or in any combination, is configured to receive, from a network entity, a configuration of at least one measurement associated with a gap length, a gap periodicity, and a gap offset. Based at least in part on information stored in the at least one memory, the at least one processor, individually or in any combination, is configured to transmit, to the network entity, UE assistance information (UAI) including a request for a first value for the gap length, a second value for the gap periodicity, or a third value for the gap offset. Based at least in part on information stored in the at least one memory, the at least one processor, individually or in any combination, is configured to receive, from the network entity, an indication associated with the first value for the gap length, the second value for the gap periodicity, or the third value for the gap offset. Based at least in part on information stored in the at least one memory, the at least one processor, individually or in any combination, is configured to perform the at least one measurement.

To the accomplishment of the foregoing and related ends, the one or more aspects include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating example measurement gaps configured for a UE, in accordance with various aspects of the present disclosure.

FIG. 5 is a diagram illustrating example measurement gaps configured for a UE, in accordance with various aspects of the present disclosure.

FIG. 6 is a diagram illustrating example measurement gaps configured for a UE, in accordance with various aspects of the present disclosure.

FIG. 7 is a diagram illustrating example measurement gaps configured for a UE, in accordance with various aspects of the present disclosure.

FIG. 8 is a diagram illustrating example measurement gaps configured for a UE, in accordance with various aspects of the present disclosure.

FIG. 9 is a diagram illustrating example communications between a network entity and a UE, in accordance with various aspects of the present disclosure.

FIG. 10 is a diagram illustrating example communications between a network entity and a UE, in accordance with various aspects of the present disclosure.

FIG. 11 is a diagram illustrating example communications between a network entity and a UE, in accordance with various aspects of the present disclosure.

FIG. 12 is a flowchart of a method of wireless communication, in accordance with various aspects of the present disclosure.

FIG. 13 is a diagram illustrating an example of a hardware implementation for an example apparatus and/or network entity.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Measurement gaps may be used for inter-frequency or inter-radio access technology (RAT) measurements configured by the network (NW). A UE may have the option to indicate to the NW if it would use gaps for intra/inter frequency, inter-RAT measurements through various signaling, such as its capability exchange signaling or an RRC message such as indicating completion of reconfiguration or resume (e.g., RRCReconfigComplete/ResumeComplete) based on which network configures the gaps. In some wireless communication systems, the UE may have no control over the gap configuration, including a periodicity of the measurement gap, a length of the measurement gap, or a offset of the measurement gap. If the UE requests for a measurement gap, the network may configure the gaps based on a gap pattern (including a gap periodicity, a gap length, or a gap offset) of the network's choice and the UE may have no control over the gap pattern. If the gap pattern is not suitable for the UE, the UE may suffer from degraded performance. For example, the gaps configured may exceed the UE's use. For example, when the UE is stationary, it might be suitable to use a low quantity of or no gaps and the network may configure too many gaps. As another example, if the UE is a dual-subscriber identity module (SIM) dual active (DSDA) UE and the second subscriber identity is inactive or idle, the UE may use the second subscriber identity for measurements without retuning to the first RF associated with the currently active (serving) subscriber identity. As another example, the gaps configured may not be sufficient to perform all measurements, which may cause radio link failure, high transmit power, or other performance degrade. Aspects provided herein enables the UE to dynamically request measurement gaps based on a state of the UE itself.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer. While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

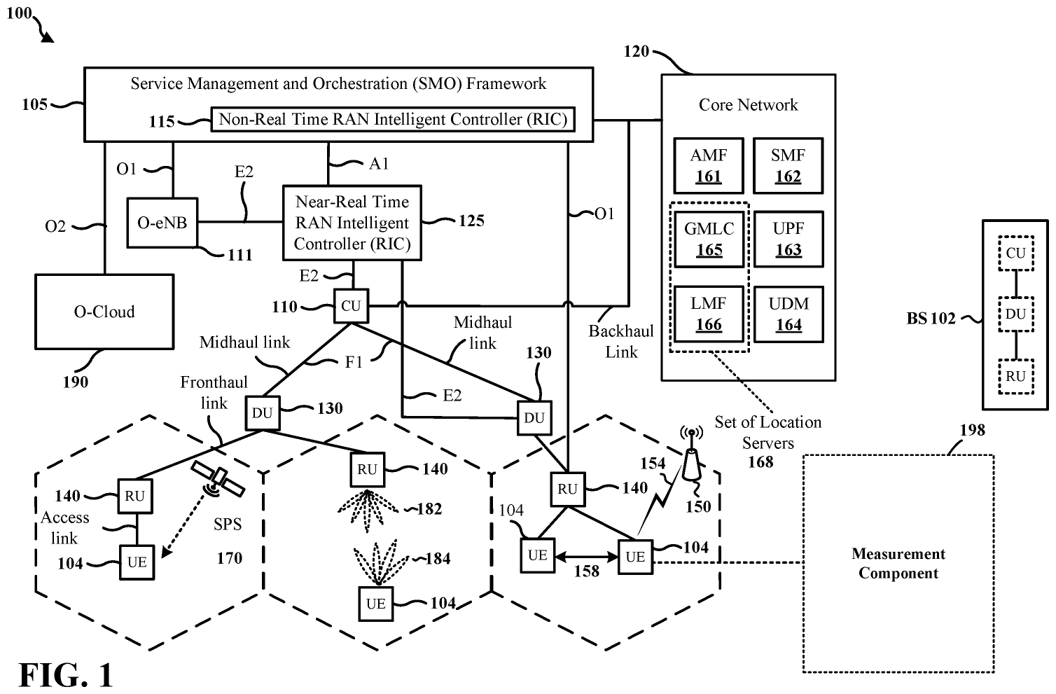

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHZ), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 may include a measurement component 198. In some aspects, the measurement component 198 may be configured to receive, from a network entity, a configuration of at least one measurement associated with a gap length, a gap periodicity, and a gap offset. In some aspects, the measurement component 198 may be further configured to transmit, to the network entity, UE assistance information (UAI) including a request for a first value for the gap length, a second value for the gap periodicity, or a third value for the gap offset. In some aspects, the measurement component 198 may be further configured to receive, from the network entity, an indication associated with the first value for the gap length, the second value for the gap periodicity, or the third value for the gap offset. In some aspects, the measurement component 198 may be further configured to perform the at least one measurement.

Although the following description may be focused on 5G NR, the concepts described herein may be applicable to other similar areas, such as LTE, LTE-A, CDMA, GSM, and other wireless technologies.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

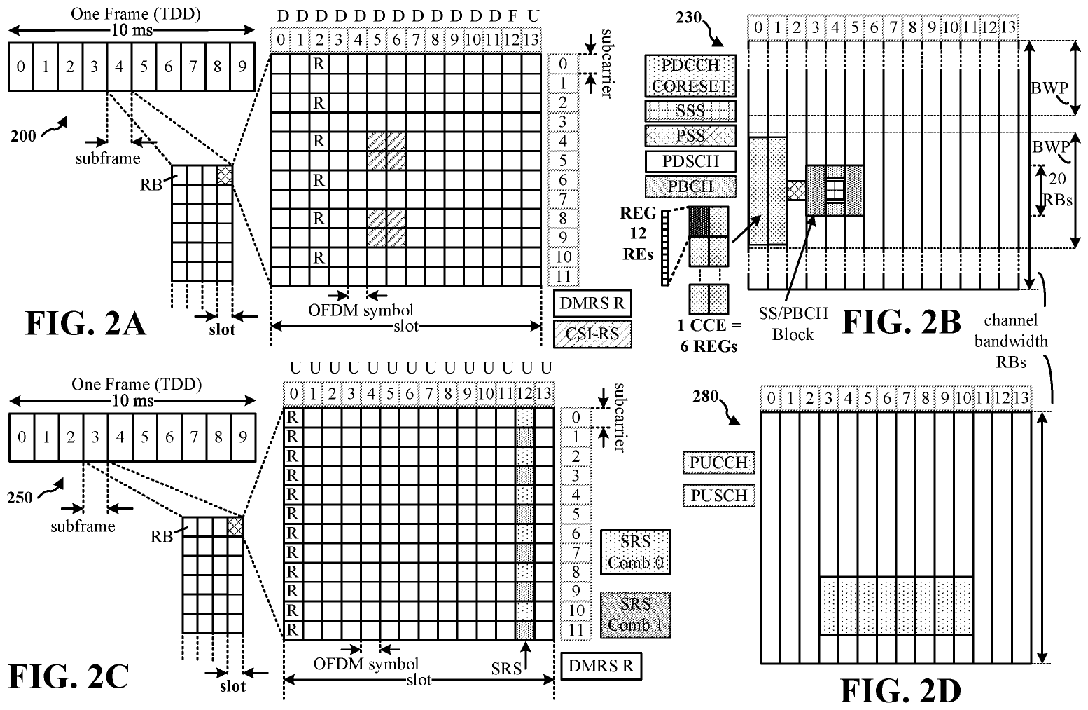

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 2^{μ}*15 kHz where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

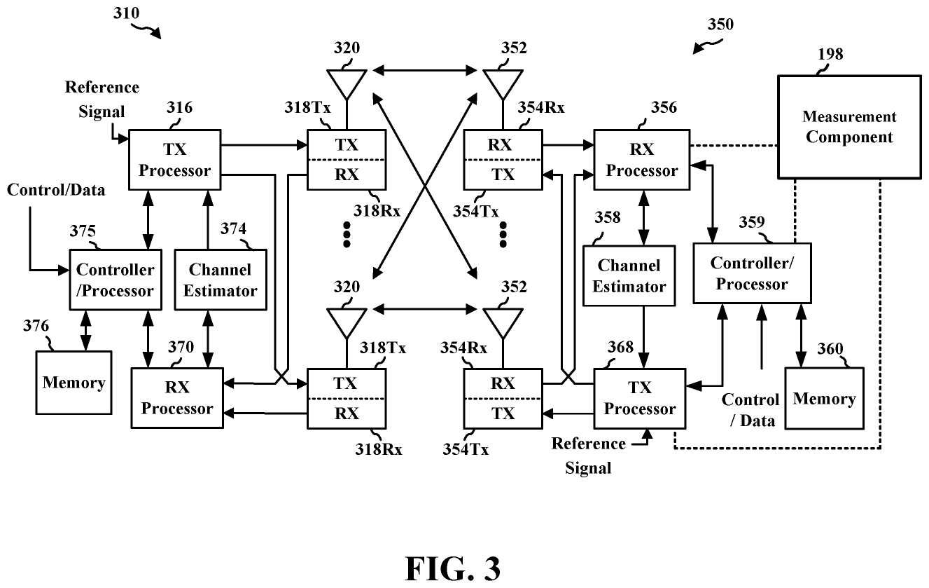

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with measurement component 198 of FIG. 1.

Measurement gaps may be used for inter-frequency or inter-radio access technology (RAT) measurements configured by the network (NW). A UE may have the option to indicate to the NW if it would use gaps for intra/inter frequency, inter-RAT measurements through various signaling, such as its capability exchange signaling or an RRC message such as indicating completion of reconfiguration or resume (e.g., RRCReconfigComplete/ResumeComplete) based on which network configures the gaps. In some wireless communication systems, the UE may have no control over the gap configuration, including a periodicity of the measurement gap, a length of the measurement gap, or a offset of the measurement gap. If the UE requests for a measurement gap, the network may configure the gaps based on a gap pattern (including a gap periodicity, a gap length, or a gap offset, or starting SFN or subframe for any aperiodic gap) of the network's choice and the UE may have no control over the gap pattern. If the gap pattern is not suitable for the UE, the UE may suffer from degraded performance. For example, the gaps configured may exceed the UE's use. For example, when the UE is stationary, it might be suitable use a low quantity of or no gaps and the network may configure too many gaps. As another example, if the UE is a dual-subscriber identity module (SIM) dual active (DSDA) UE and the second subscriber identity is inactive or idle, the UE may use the second subscriber identity for measurements without retuning to the first RF associated with the currently active (serving) subscriber identity. As another example, the gaps configured may not be sufficient to perform all measurements, which may cause radio link failure, high transmit power, or other performance degrade. As another example, if the UE is an IoT device, the UE may have less motion and may use fewer measurement gaps compared to a highly mobile UE. Aspects provided herein enables the UE to dynamically request measurement gaps based on a state of the UE itself.

In some aspects, in multi-subscriber identity module (SIM) (MSIM or MUSIM), a UE may be in connected state on network A (based on a first subscriber identity) and may be tuning away to network B (based on a second subscriber identity) temporarily for paging, measurements, or the like. This may cause degradation in performance on the first subscriber identity. In some wireless communication systems, measurement gaps may be scheduled on network A for performing MSIM activities while staying in connected state. As an example, the network A may configure at most 3 gap patterns for MUSIM purpose including two periodic gaps and a single aperiodic gap. An example MUSIM gap configuration is provided below:

| | |
|---|---|
| MUSIM-GapConfig-r17 ::= | SEQUENCE { |
| musim-GapToReleaseList-r17 | SEQUENCE (SIZE (1..3)) OF MUSIM-GapId- |

r17 OPTIONAL, -- Need N

| | |
|---|---|
| musim-GapToAddModList-r17 | SEQUENCE (SIZE (1..3)) OF MUSIM-Gap- |

r17 OPTIONAL, -- Need N

| | |
|---|---|
| musim-AperiodicGap-r17 | MUSIM-GapInfo-r17 OPTIONAL, -- |

Need N
...
}

| | |
|---|---|
| MUSIM-Gap-r17 ::= | SEQUENCE { |
| musim-GapId-r17 | MUSIM-GapId-r17, |
| musim-GapInfo-r17 | MUSIM-GapInfo-r17 |

}

In some aspects, the IE MUSIM-GapConfig specifies the MUSIM gap configuration and controls setup/release of MUSIM gaps. The IE musim-AperiodicGap may indicate the MUSIM aperiodic gap. If UE indicates the musim-Starting-SFN-AndSubframe when requesting aperiodic gap the network may configure the aperiodic gap with the same start point or no aperiodic gap. If the field musim-Starting-SFN-AndSubframe is absent for aperiodic gap, network may configure any timing as the starting point for aperiodic gap or configure no aperiodic gap. The IE musim-GapInfo may indicate the values for musim-GapLength and musim-GapRepetitionAndOffset. The IE musim-GapToAddModList may indicate the MUSIM periodic gap patterns to add or modify and the IE musim-GapToReleaseList may indicate MUSIM periodic gap patterns to release. An example of IE MUSIM-GapInfo, which provides information for gap pattern, is provided below:

| | |
|---|---|
| MUSIM-GapInfo-r17 ::= | SEQUENCE { |
| musim-Starting-SFN-AndSubframe-r17 | MUSIM-Starting-SFN-AndSubframe-r17 |

OPTIONAL, -- Cond aperiodic

| | |
|---|---|
| musim-GapLength-r17 | ENUMERATED {ms3, ms4, ms6, ms10, ms20} |

OPTIONAL, -- Cond gapSetup

| | |
|---|---|
| musim-GapRepetitionAndOffset-r17 | CHOICE { |
| ms20-r17 | INTEGER (0..19), |
| ms40-r17 | INTEGER (0..39), |
| ms80-r17 | INTEGER (0..79), |
| ms160-r17 | INTEGER (0..159), |
| ms320-r17 | INTEGER (0..319), |
| ms640-r17 | INTEGER (0..639), |
| ms1280-r17 | INTEGER (0..1279), |
| ms2560-r17 | INTEGER (0..2559), |
| ms5120-r17 | INTEGER (0..5119), |

...

| | |
|---|---|
| } | OPTIONAL -- Cond periodic |

}
MUSIM-Starting-SFN-AndSubframe-r17 ::= SEQUENCE {

| | |
|---|---|
| starting-SFN-r17 | INTEGER (0..1023), |
| startingSubframe-r17 | INTEGER (0..9) |

}

The IE musim-GapLength may indicate gap length. The IE musim-GapRepetitionAndOffset may indicate the gap repetition period (which may be referred to as “periodicity”) in milliseconds and gap offset in number of subframes for the periodic MUSIM gap. The IE musim-Starting-SFN-AndSubframe may indicate gap starting position for the aperiodic MUSIM gap. The IE starting-SFN may indicate gap starting SFN number for the aperiodic MUSIM gap. The IE startingSubframe may indicate gap starting subframe number for the aperiodic MUSIM gap.

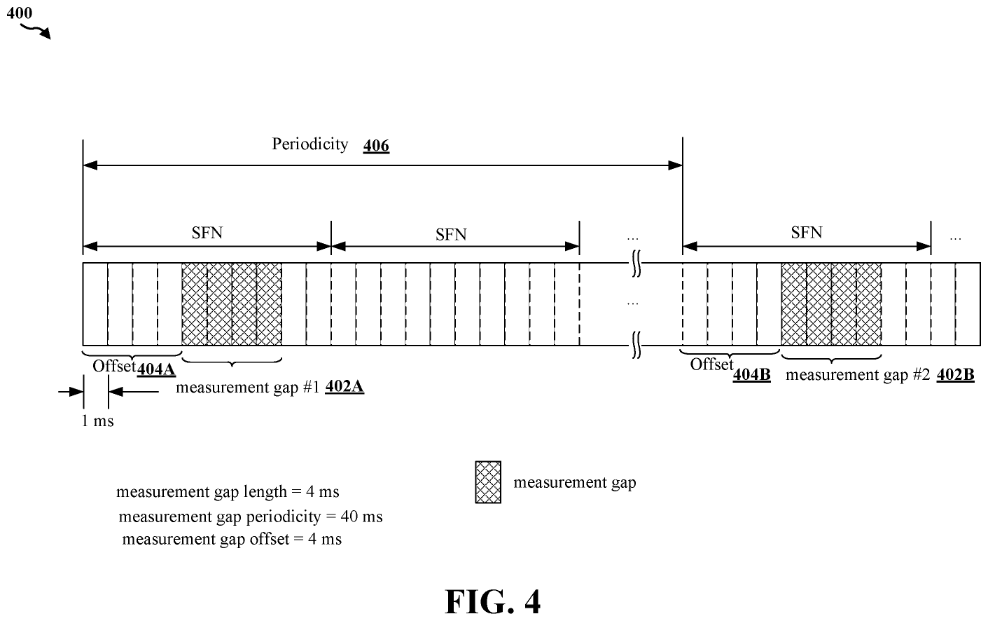

FIG. 4 is a diagram 400 illustrating example measurement gaps configured for a UE, in accordance with various aspects of the present disclosure. As illustrated in FIG. 4, A set of periodic measurement gaps including a first measurement gap 402A and a second measurement gap 402B may be configured. The first measurement gap 402A may be away from a start of an SFN associated with the measurement gap 402A by an offset 404A. The second measurement gap 402B may be away from a start of an SFN associated with the measurement gap 402B by an offset 404B. The offset may be 4 milliseconds. The length of each measurement gap in the set of periodic measurement gaps may be equal to a configured gap length, such as 4 milliseconds. The periodicity 406 associated with the set of periodic measurement gaps may be 40 milliseconds.

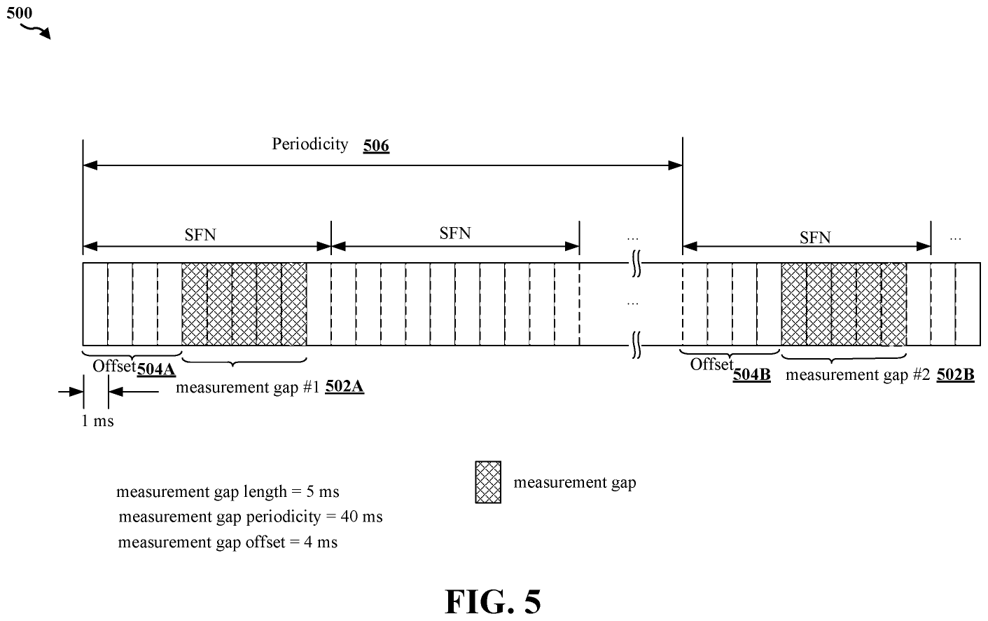

FIG. 5 is a diagram 500 illustrating example measurement gaps configured for a UE, in accordance with various aspects of the present disclosure. As illustrated in FIG. 5, A set of periodic measurement gaps including a first measurement gap 502A and a second measurement gap 502B may be configured. The first measurement gap 502A may be away from a start of an SFN associated with the measurement gap 502A by an offset 504A. The second measurement gap 502B may be away from a start of an SFN associated with the measurement gap 502B by an offset 504B. The offset may be 4 milliseconds. The length of each measurement gap in the set of periodic measurement gaps may be equal to a configured gap length, such as 5 milliseconds. The periodicity 506 associated with the set of periodic measurement gaps may be 40 milliseconds.

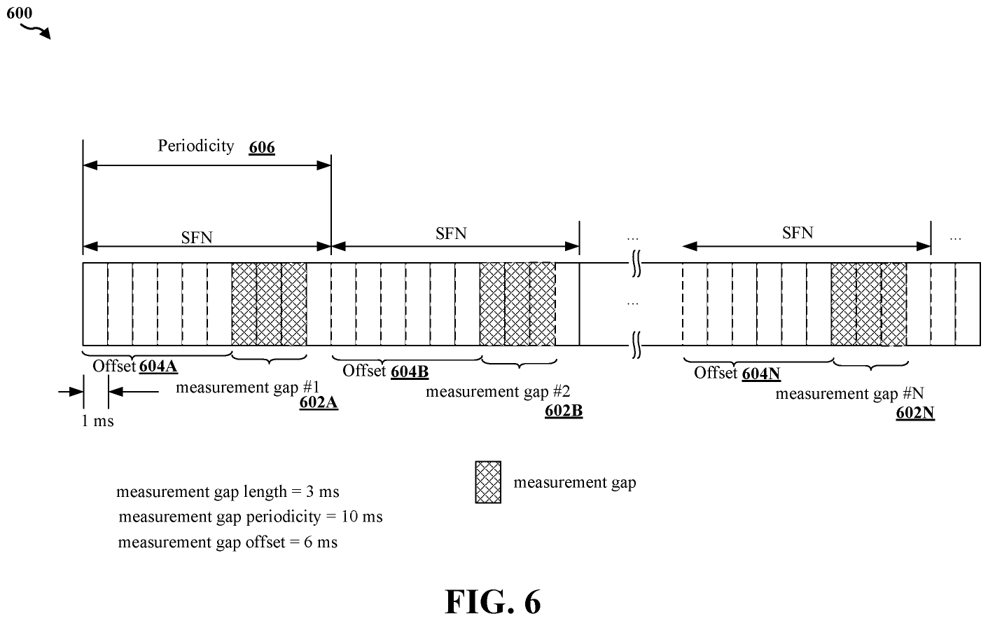

FIG. 6 is a diagram 600 illustrating example measurement gaps configured for a UE, in accordance with various aspects of the present disclosure. As illustrated in FIG. 6, A set of periodic measurement gaps including a first measurement gap 602A and a second measurement gap 602B may be configured. The first measurement gap 602A may be away from a start of an SFN associated with the measurement gap 602A by an offset 604A. The second measurement gap 602B may be away from a start of an SFN associated with the measurement gap 602B by an offset 604B. The offset may be 6 milliseconds. The length of each measurement gap in the set of periodic measurement gaps may be equal to a configured gap length, such as 3 milliseconds. There may be a Nth measurement gap 602N configured for the UE and the Nth measurement gap 602N may be away from a start of an SFN associated with the Nth measurement gap 602N by an offset 604N. The periodicity 606 associated with the set of periodic measurement gaps may be 10 milliseconds.

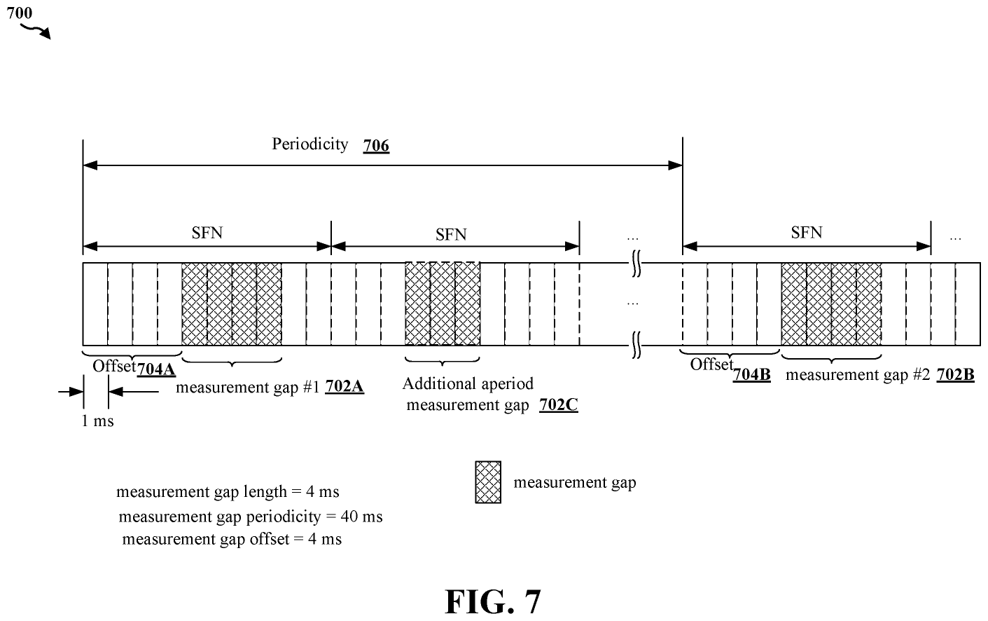

FIG. 7 is a diagram 700 illustrating example measurement gaps configured for a UE, in accordance with various aspects of the present disclosure. As illustrated in FIG. 7, A set of periodic measurement gaps including a first measurement gap 702A and a second measurement gap 702B may be configured. The first measurement gap 702A may be away from a start of an SFN associated with the measurement gap 702A by an offset 704A. The second measurement gap 702B may be away from a start of an SFN associated with the measurement gap 702B by an offset 704B. The offset may be 4 milliseconds. The length of each measurement gap in the set of periodic measurement gaps may be equal to a configured gap length, such as 4 milliseconds. The periodicity 706 associated with the set of periodic measurement gaps may be 40 milliseconds. In addition to the set of periodic measurement gaps, there may be an additional aperiodic measurement gap 702C configured for the UE based on the UE's request (e.g., via UAI).

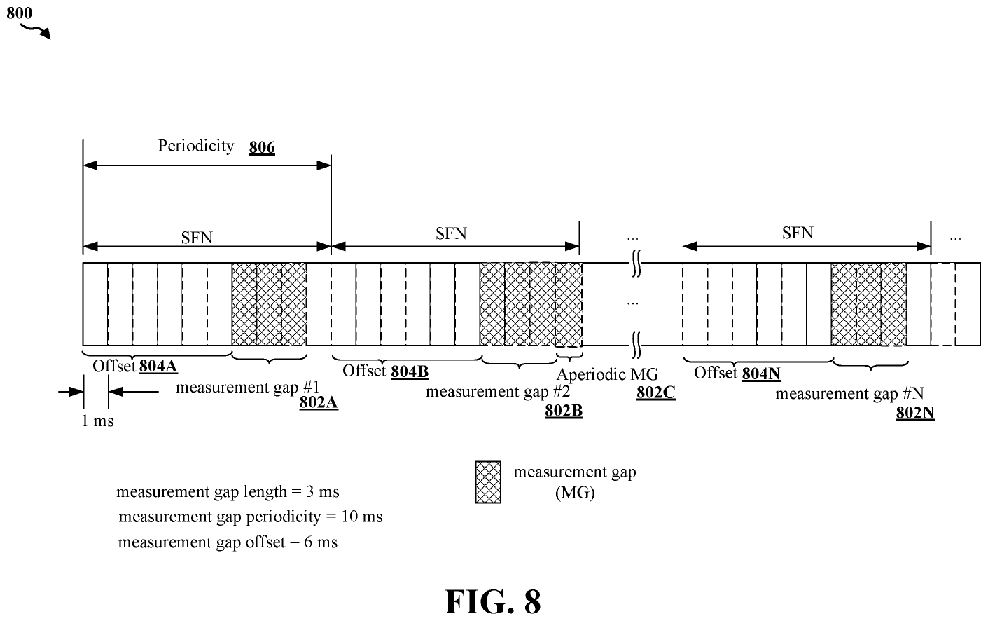

FIG. 8 is a diagram 800 illustrating example measurement gaps configured for a UE, in accordance with various aspects of the present disclosure. As illustrated in FIG. 8, A set of periodic measurement gaps including a first measurement gap 802A and a second measurement gap 802B may be configured. The first measurement gap 802A may be away from a start of an SFN associated with the measurement gap 802A by an offset 804A. The second measurement gap 802B may be away from a start of an SFN associated with the measurement gap 802B by an offset 804B. The offset may be 8 milliseconds. The length of each measurement gap in the set of periodic measurement gaps may be equal to a configured gap length, such as 3 milliseconds. There may be a Nth measurement gap 802N configured for the UE and the Nth measurement gap 802N may be away from a start of an SFN associated with the Nth measurement gap 802N by an offset 804N. The periodicity 806 associated with the set of periodic measurement gaps may be 10 milliseconds. In addition to the set of periodic measurement gaps, there may be an additional aperiodic measurement gap 802C configured for the UE based on the UE's request (e.g., via UAI).

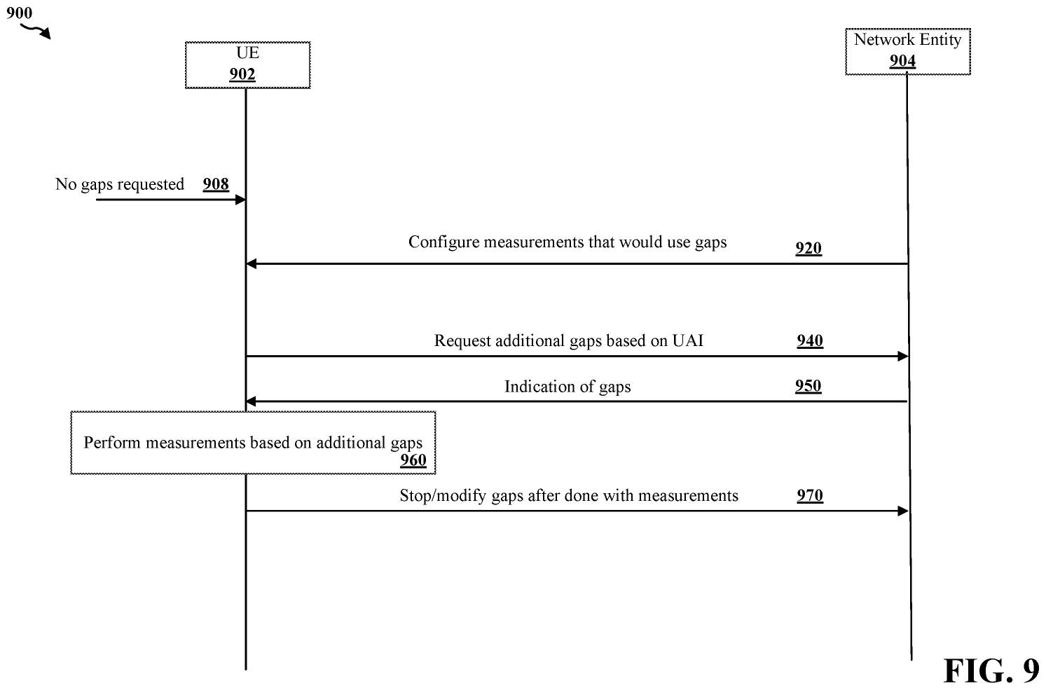

FIG. 9 is a diagram 900 illustrating example communications between a network entity 904 and a UE 902, in accordance with various aspects of the present disclosure. As illustrated in FIG. 9, in some aspects, at 908, the UE 902 may not request a measurement gap. The network entity 904 may configure, at 920, one or more measurements that would need measurement gaps. Based on the configuration at 920, the UE 902 may, at 940, transmit UAI to the network entity 904 to request a set of periodic measurement gaps that may be associated with a particular gap pattern (which includes a gap periodicity, a gap offset, or a gap length, or starting SFN or subframe for any aperiodic gap). In some aspects, at 940, the UE 902 may also request aperiodic measurement gap(s). In some aspects, the network entity 904 may, at 950, provide an indication associated with the measurement gaps. In some aspects, the particular gap pattern may be based on any particular gap periodicity, any particular gap offset, or any particular gap length. For example, the requested gap pattern may be similar to any of the measurement gaps illustrated in FIG. 4, FIG. 5, FIG. 6, FIG. 7, or FIG. 8. In some aspects, the network entity 904 may approve the requested gap pattern and provide a configuration of a set of measurement gaps based on the particular gap pattern requested. In some aspects, the network entity 904 may deny the requested gap pattern and provide a configuration of a set of measurement gaps different from the particular gap pattern requested. In some aspects, based on the provided configuration of measurement gaps, the UE 902 may, at 960 perform one or more measurements. In some aspects, the UE 902 may dynamically determine that it no longer uses the configured measurement gaps and may, at 970, transmit an indication to stop or modify the configured gaps (e.g., via UAI).

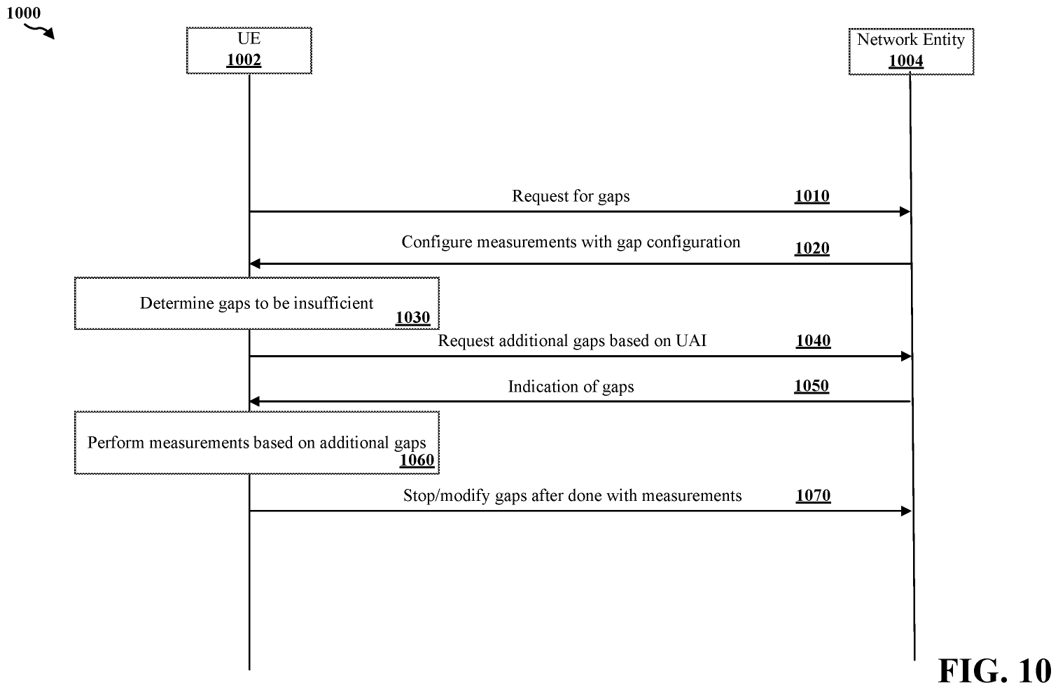

FIG. 10 is a diagram 1000 illustrating example communications between a network entity 1004 and a UE 1002, in accordance with various aspects of the present disclosure. As illustrated in FIG. 10, in some aspects, at 1010, the UE 1002 may request a measurement gap (e.g., via a signaling) from the network entity 1004. The network entity 1004 may configure, at 1020, one or more measurements with a particular measurement configuration with a gap pattern (e.g., a which includes a gap periodicity, a gap offset, or a gap length, or starting SFN or subframe for any aperiodic gap). For example, the configured gap pattern may be similar to any one of the measurement gaps illustrated in FIG. 4, FIG. 5, FIG. 6, FIG. 7, or FIG. 8.

In some aspects, at 1030, the UE 1002 may determine the configured gaps to be insufficient or otherwise unsuitable (e.g., too many gaps configured). Based on the determination at 1030, the UE 1002 may, at 1040, transmit UAI to the network entity 1004 to request a set of periodic measurement gaps that may be associated with a particular gap pattern (which includes a gap periodicity, a gap offset, or a gap length, or starting SFN or subframe for any aperiodic gap). In some aspects, at 1040, the UE 1002 may also request additional aperiodic measurement gap(s). In some aspects, the request at 1040 would request gaps different from the gaps configured at 1020.

In some aspects, the network entity 1004 may, at 1050, provide an indication associated with the measurement gaps. In some aspects, the particular gap pattern may be based on any particular gap periodicity, any particular gap offset, or any particular gap length. For example, the requested gap pattern may be similar to a different one of the measurement gaps illustrated in FIG. 4, FIG. 5, FIG. 6, FIG. 7, or FIG. 8. In some aspects, the network entity 1004 may approve the requested gap pattern and provide a configuration of a set of measurement gaps based on the particular gap pattern requested. In some aspects, the network entity 1004 may deny the requested gap pattern and provide a configuration of a set of measurement gaps different from the particular gap pattern requested. In some aspects, based on the provided configuration of measurement gaps, the UE 1002 may, at 1060 perform one or more measurements. In some aspects, the UE 1002 may dynamically determine that it no longer uses the configured measurement gaps and may, at 1070, transmit an indication to stop or modify the configured gaps (e.g., via UAI).

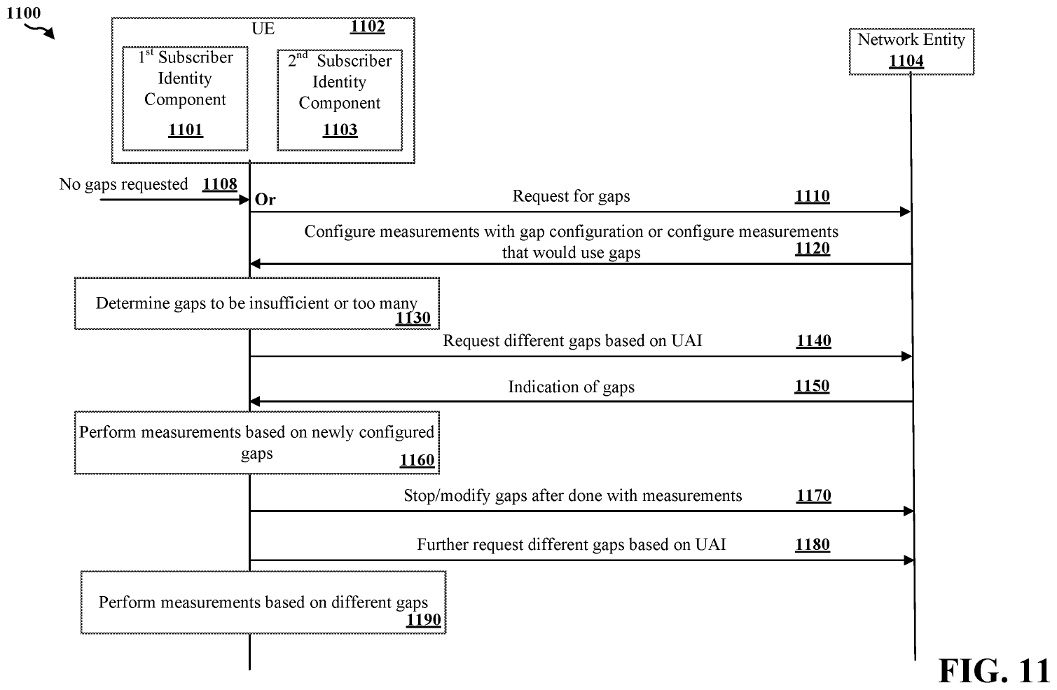

FIG. 11 is a diagram 1100 illustrating example communications between a network entity 1104 and a UE 1102, in accordance with various aspects of the present disclosure. In some aspects, the UE 1102 may be associated with a first subscriber identity 1101 and a second subscriber identity 1103.

In some aspects, As illustrated in FIG. 11, in some aspects, at 1108, the UE 1102 may not request a measurement gap. The network entity 1104 may configure, at 1120, one or more measurements that would use measurement gaps. Based on the configuration at 1120, the UE 1102 may, at 1140, transmit UAI to the network entity 1104 to request a set of periodic measurement gaps that may be associated with a particular gap pattern (which includes a gap periodicity, a gap offset, or a gap length, or starting SFN or subframe for any aperiodic gap).

Alternatively or additionally, as illustrated in FIG. 11, in some aspects, at 1110, the UE 1102 may request a measurement gap (e.g., via a signaling) from the network entity 1104. The network entity 1104 may configure, at 1120, one or more measurements with a particular measurement configuration with a gap pattern (e.g., a which includes a gap periodicity, a gap offset, or a gap length, or starting SFN or subframe for any aperiodic gap). In some aspects, at 1130, the UE 1102 may determine the configured gaps to be insufficient or otherwise unsuitable (e.g., too many gaps configured). Based on the determination at 1130, the UE 1102 may, at 1140, transmit UAI to the network entity 1104 to request a set of periodic measurement gaps that may be associated with a particular gap pattern (which includes a gap periodicity, a gap offset, or a gap length, or starting SFN or subframe for any aperiodic gap). In some aspects, at 1140, the UE 1102 may also request additional aperiodic measurement gap(s). In some aspects, the request at 1140 would request gaps different from the gaps configured at 1120.

In some aspects, the network entity 1104 may, at 1150, provide an indication associated with the measurement gaps. In some aspects, the particular gap pattern may be based on any particular gap periodicity, any particular gap offset, or any particular gap length. For example, the requested gap pattern may be similar to any of the measurement gaps illustrated in FIG. 4, FIG. 5, FIG. 6, FIG. 7, or FIG. 8. In some aspects, the network entity 1104 may approve the requested gap pattern and provide a configuration of a set of measurement gaps based on the particular gap pattern requested. In some aspects, the network entity 1104 may deny the requested gap pattern and provide a configuration of a set of measurement gaps different from the particular gap pattern requested. In some aspects, based on the provided configuration of measurement gaps, the UE 1102 may, at 1160 perform one or more measurements based on the gaps configured at 1150. In some aspects, the UE 1102 may dynamically determine that it no longer uses the configured measurement gaps and may, at 1170, transmit an indication to stop or modify the configured gaps (e.g., via UAI). In some aspects, the UE 1102 may, at 1180, further request different gaps associated with a particular pattern (e.g., which may be the same or different from the gap pattern requested at 1140) and may perform measurements at 1190 accordingly. In some aspects, the measurements may facilitate inter-RAT or inter-frequency operations enabled by the first subscriber identity 1101 and the second subscriber identity 1103. In some aspects, the particular gap pattern requested may be based on a state associated with the UE 1102 such as a mobility state, battery status, UE type, channel status or the like. For example, the UE 1102 may request less gaps when its stationary or its channel conditions are good. When there is high mobility or the channel conditions degrade, the UE 1102 may dynamically (e.g., immediately request via UAI) request for more gaps to perform neighbor measurements quickly and frequently. The measurement gaps may be started/stopped by the UE 1102 itself and the UE 1102 may dynamically enable/disable the gaps based on its state. In some aspects, the UE 1102 may follow legacy behavior (e.g., by requesting gaps) first, then request for additional/different gaps if the gaps configured are not sufficient or too much.

In some aspects, if the network entity 1104 denies the requested gap and do not provide the requested gap, the UE 1102 may wait until an expiration of a timer, such as a T346h timer to determine if the NW is not providing a gap. For example, if the network entity 1104 do not provide the requested gap, the UE 1102 may fallback to a different behavior, such as a legacy behavior for requesting gaps (e.g., via a different signaling Capability, Reconfigcomplete, or ResumeComplete or use a different gap other than the requested gap pattern, such as using a gap pattern configured at 1120). In some aspects, if the timer expires and the gap is not provided, UE may open virtual gaps by sending channel quality indicator (CQI) as 0 or the UE 1102 may send a new capability by setting “capability needed” in a signaling to the network entity 1104. In some aspects, the UE 1102 may request gaps (e.g., periodic or aperiodic) at 1140 or 1170 using a particular type of UAI, such as MUSIM Assistance information in a single SIM mode. In some aspects, the UE 1102 may request gaps at 1140 or 1170 based on a signaling different from a capability signaling or a signaling that indicates RRC reconfiguration complete or RRC resume complete (e.g., Capability/RRCReconfigComplete/RRCResumeComplete). In some aspects, the UE 1102 may request gaps (e.g., periodic or aperiodic) at 1140 or 1170 using signaling that may not be in line with a paging cycle associated with a first SIM or a second SIM associated with the UE. In some aspects, the UE 1102 may request gaps (e.g., periodic or aperiodic) at 1140 or 1170 based on a change of state, such as a change in channel condition, a change in mobility state, a change in battery status, or the like. In some aspects, the requested gaps and the configured gaps may be MUSIM gaps.

Some aspects provided herein dynamically uses the MUSIM gap configuration request based on UAI to enable a UE to request gaps based on its state. In some aspects, the UE may use UAI to request different gaps based on a change in its state. Because suitable gaps may be different based on the UE's state, a UE may be able to integrate artificial intelligence or machine learning in determining the gaps to be requested. Aspects provided herein enables the UE to request the gaps that the UE determines to be the most suitable/efficient. As another example benefit, aspects provided herein may enable a UE in the form of an IoT device to request aperiodic gaps to ensure it's served by a best cell. In some aspects, a UE with non-terrestrial network (NTN) coverage and TN coverage may request for gaps so that the UE may measure for the NTN coverage when (e.g., conditioned on) the TN coverage gets poor.

In some aspects, when a UE would use a single gap, the UE may request for aperiodic gap by specifying the starting SFN/subframe. For example, in some scenarios, the measurements that may be used may spike up while the serving cell condition became poor or the UE may determine that there is no UL data activity for a short time (which is not periodic) and there are measurements to be done or the serving cell is fast becoming worst (e.g., in high speed train) and the UE may not want to wait for a next gap. In some scenarios where the UE is stationary and may be configured with gaps of high periodicity (e.g., less frequent), when there is a sudden change in serving cell channel conditions (e.g., based on a reference signal received power (RSRP) threshold, a received signal strength indicator (RSSI) threshold, a signal to interference and noise ratio (SINR) threshold, or the like), the UE may request for an aperiodic gap to check how the neighbor cells are faring. For example, the UE may use these results to decide if it would increase the periodic gaps. If the neighbors become good, the UE may monitor the neighbors more frequently to determine whether to switch serving cell in case of any abrupt motion, signal change, or other changes in the UE's state.

In some aspects, the UE may not use as much gaps as configured by the network and the UE may have additional chains which can be utilized for measurements in which case the UE may use less gaps than configured. For example, the UE may have two mid-band (MB) reception chains and two low-band (LB) reception chains. If the UE's serving cell is on MB and if measurements are configured by network on LB, the amount of gaps used may be reduced. In some aspects, for DSDA or dual-SIM dual standby (DSDS) in dual receive, if one subscriber identity (SUB) is operating on MB and in connected state and another SUB is on LB and is also in connected state, SUB1 cannot get the LB chains to measure LB and thus need measurement gaps. If SUB2 moves to idle state or is disabled, the SUB1 may get LB chains. Thus, it depends on the UE's present state/capability to determine the quantity of gaps to be used which the network is not aware of.

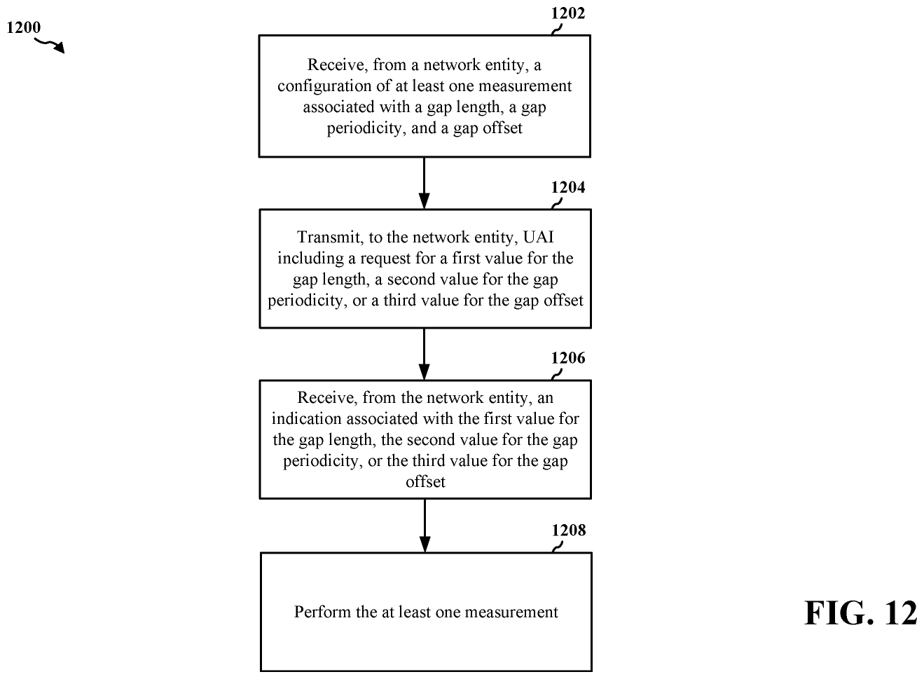

FIG. 12 is a flowchart 1200 of a method of wireless communication. The method may be performed by a UE (e.g., the UE 104; the apparatus 1304). The aspects provided herein may enable the UE to dynamically request measurement gaps so that the configured measurement gaps would be more suitable for the UE, increasing overall performance of the UE.

At 1202, the UE may receive, from a network entity, a configuration of at least one measurement associated with a gap length, a gap periodicity, and a gap offset. For example, the UE 1102 may receive, from a network entity 1104, a configuration (e.g., 1120) of at least one measurement associated with a gap length, a gap periodicity, and a gap offset. In some aspects, 1202 may be performed by measurement component 198. In some aspects, the configuration of the at least one measurement includes a fourth value for the gap length, a fifth value for the gap periodicity, or a sixth value for the gap offset, where the first value is different from the fourth value, the second value is different from the fifth value, and the third value is different from the sixth value. In some aspects, at least one of the first value, the second value, or the third value is based on a mobility condition or a channel condition of the UE.

At 1204, the UE may transmit, to the network entity, UAI including a request for a first value for the gap length, a second value for the gap periodicity, or a third value for the gap offset. For example, the UE 1102 may transmit, to the network entity, UAI (e.g., 1140) including a request for a first value for the gap length, a second value for the gap periodicity, or a third value for the gap offset. In some aspects, 1204 may be performed by measurement component 198.

At 1206, the UE may receive, from the network entity, an indication associated with the first value for the gap length, the second value for the gap periodicity, or the third value for the gap offset. For example, the UE 1102 may receive, from the network entity, an indication (e.g., 1150) associated with the first value for the gap length, the second value for the gap periodicity, or the third value for the gap offset. In some aspects, 1206 may be performed by measurement component 198.

At 1208, the UE may perform the at least one measurement. For example, the UE 1102 may perform (e.g., 1160) the at least one measurement. In some aspects, 1208 may be performed by measurement component 198. In some aspects, the indication provides the first value for the gap length, the second value for the gap periodicity, or the third value for the gap offset, or indicates an approval of the request, and where to perform the at least one measurement, the UE may perform the at least one measurement based on the first value for the gap length, the second value for the gap periodicity, or the third value for the gap offset.

In some aspects, the UE may transmit, to the network entity, a second UAI to disable the first value for the gap length, the second value for the gap periodicity, or the third value for the gap offset and refrain from performing at least one additional measurement based on the first value for the gap length, the second value for the gap periodicity, or the third value for the gap offset. In some aspects, the UE may transmit, to the network entity, a third UAI to enable the first value for the gap length, the second value for the gap periodicity, or the third value for the gap offset and perform at least one second additional measurement based on the first value for the gap length, the second value for the gap periodicity, or the third value for the gap offset. In some aspects, the UE may transmit, to the network entity, a third UAI including a second request for a fourth value for the gap length, a fifth value for the gap periodicity, or a sixth value for the gap offset.

In some aspects, the indication does not provide the first value for the gap length, the second value for the gap periodicity, or the third value for the gap offset, or indicates a denial of the request, and where to perform the at least one measurement, the UE may perform the at least one measurement based on a fourth value for the gap length, a fifth value for the gap periodicity, or a sixth value for the gap offset, where the first value is different from the fourth value, the second value is different from the fifth value, and the third value is different from the sixth value.

In some aspects, the UE may start a timer upon a transmission of the UAI and based on lack of reception of the first value for the gap length, the second value for the gap periodicity, or the third value for the gap offset in the indication before the timer expires, perform the at least one measurement based on one or more virtual gaps.

In some aspects, the UE may open the one or more virtual gaps by setting a channel quality indicator (CQI) as zero and transmit an indication of a capability associated with the one or more virtual gaps.

In some aspects, the request is for an aperiodic gap and the UAI does not include the second value for the gap periodicity, and where the UAI further includes a starting position associated with the aperiodic gap. In some aspects, the UE may perform the at least one measurement based on the aperiodic gap and based on a result of the at least one measurement, transmit a second UAI including a second request for a fourth value of the gap periodicity. In some aspects, the request is for the aperiodic gap is based on a change of a mobility state, a channel condition, or a signal condition of the UE.

In some aspects, the request is based on a performance of a terrestrial network (TN) coverage condition associated with the UE being below a threshold. In some aspects, the UE may prior to a reception of the configuration, transmit, to the network entity, a request (e.g., 1110) for at least one measurement gap.

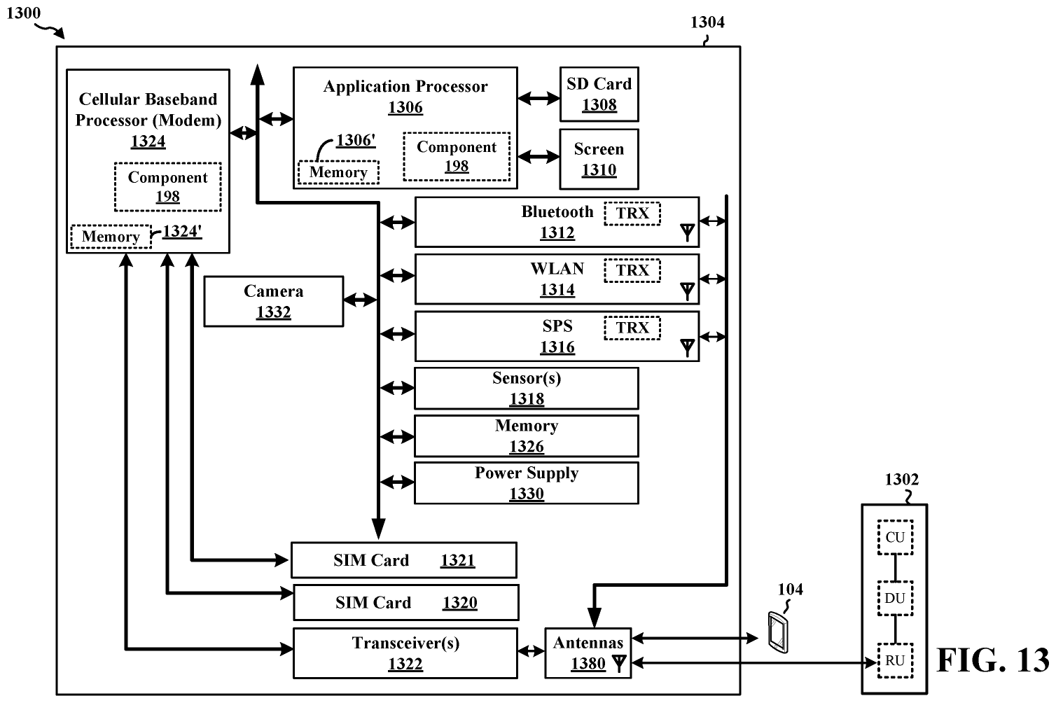

FIG. 13 is a diagram 1300 illustrating an example of a hardware implementation for an apparatus 1304. The apparatus 1304 may be a UE, a component of a UE, or may implement UE functionality. In some aspects, the apparatus 1304 may include at least one cellular baseband processor 1324 (also referred to as a modem) coupled to one or more transceivers 1322 (e.g., cellular RF transceiver). The cellular baseband processor(s) 1324 may include at least one on-chip memory 1324′. In some aspects, the apparatus 1304 may further include one or more subscriber identity modules (SIM) cards including a first SIM card 1320 and a second SIM card 1321 and at least one application processor 1306 coupled to a secure digital (SD) card 1308 and a screen 1310. The application processor(s) 1306 may include on-chip memory 1306′. In some aspects, the apparatus 1304 may further include a Bluetooth module 1312, a WLAN module 1314, an SPS module 1316 (e.g., GNSS module), one or more sensor modules 1318 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1326, a power supply 1330, and/or a camera 1332. The Bluetooth module 1312, the WLAN module 1314, and the SPS module 1316 may include an on-chip transceiver (TRX) (or in some cases, just a receiver (RX)). The Bluetooth module 1312, the WLAN module 1314, and the SPS module 1316 may include their own dedicated antennas and/or utilize the antennas 1380 for communication. The cellular baseband processor(s) 1324 communicates through the transceiver(s) 1322 via one or more antennas 1380 with the UE 104 and/or with an RU associated with a network entity 1302. The cellular baseband processor(s) 1324 and the application processor(s) 1306 may each include a computer-readable medium/memory 1324′, 1306′, respectively. The additional memory modules 1326 may also be considered a computer-readable medium/memory. Each computer-readable medium/memory 1324′, 1306′, 1326 may be non-transitory. The cellular baseband processor(s) 1324 and the application processor(s) 1306 are each responsible for general processing, including the execution of software stored on the computer-readable medium/memory. The software, when executed by the cellular baseband processor(s) 1324/application processor(s) 1306, causes the cellular baseband processor(s) 1324/application processor(s) 1306 to perform the various functions described supra. The computer-readable medium/memory may also be used for storing data that is manipulated by the cellular baseband processor(s) 1324/application processor(s) 1306 when executing software. The cellular baseband processor(s) 1324/application processor(s) 1306 may be a component of the UE 350 and may include the at least one memory 360 and/or at least one of the TX processor 368, the RX processor 356, and the controller/processor 359. In one configuration, the apparatus 1304 may be at least one processor chip (modem and/or application) and include just the cellular baseband processor(s) 1324 and/or the application processor(s) 1306, and in another configuration, the apparatus 1304 may be the entire UE (e.g., see UE 350 of FIG. 3) and include the additional modules of the apparatus 1304.

As discussed supra, the measurement component 198 may be configured to receive, from a network entity, a configuration of at least one measurement associated with a gap length, a gap periodicity, and a gap offset. In some aspects, the measurement component 198 may be further configured to transmit, to the network entity, UAI including a request for a first value for the gap length, a second value for the gap periodicity, or a third value for the gap offset. In some aspects, the measurement component 198 may be further configured to receive, from the network entity, an indication associated with the first value for the gap length, the second value for the gap periodicity, or the third value for the gap offset. In some aspects, the measurement component 198 may be further configured to perform the at least one measurement. The measurement component 198 may be within the cellular baseband processor(s) 1324, the application processor(s) 1306, or both the cellular baseband processor(s) 1324 and the application processor(s) 1306. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1304 may include a variety of components configured for various functions. In one configuration, the apparatus 1304, and in particular the cellular baseband processor(s) 1324 and/or the application processor(s) 1306, may include means for receiving, from a network entity, a configuration of at least one measurement associated with a gap length, a gap periodicity, and a gap offset. In some aspects, the apparatus 1304 may include means for transmitting, to the network entity, UAI including a request for a first value for the gap length, a second value for the gap periodicity, or a third value for the gap offset. In some aspects, the apparatus 1304 may include means for receiving, from the network entity, an indication associated with the first value for the gap length, the second value for the gap periodicity, or the third value for the gap offset. In some aspects, the apparatus 1304 may include means for performing the at least one measurement. In some aspects, the apparatus 1304 may include means for performing the at least one measurement based on the first value for the gap length, the second value for the gap periodicity, or the third value for the gap offset. In some aspects, the apparatus 1304 may include means for transmitting, to the network entity, a second UAI to disable the first value for the gap length, the second value for the gap periodicity, or the third value for the gap offset. In some aspects, the apparatus 1304 may include means for refraining from performing at least one additional measurement based on the first value for the gap length, the second value for the gap periodicity, or the third value for the gap offset. In some aspects, the apparatus 1304 may include means for transmitting, to the network entity, a third UAI to enable the first value for the gap length, the second value for the gap periodicity, or the third value for the gap offset. In some aspects, the apparatus 1304 may include means for performing at least one second additional measurement based on the first value for the gap length, the second value for the gap periodicity, or the third value for the gap offset. In some aspects, the apparatus 1304 may include means for transmitting, to the network entity, a third UAI including a second request for a fourth value for the gap length, a fifth value for the gap periodicity, or a sixth value for the gap offset. In some aspects, the apparatus 1304 may include means for performing the at least one measurement based on a fourth value for the gap length, a fifth value for the gap periodicity, or a sixth value for the gap offset, where the first value is different from the fourth value, the second value is different from the fifth value, and the third value is different from the sixth value. In some aspects, the apparatus 1304 may include means for starting a timer upon a transmission of the UAI. In some aspects, the apparatus 1304 may include means for based on lack of reception of the first value for the gap length, the second value for the gap periodicity, or the third value for the gap offset in the indication before the timer expires, performing the at least one measurement based on one or more virtual gaps. In some aspects, the apparatus 1304 may include means for opening the one or more virtual gaps by setting a channel quality indicator (CQI) as zero. In some aspects, the apparatus 1304 may include means for transmitting an indication of a capability associated with the one or more virtual gaps. In some aspects, the apparatus 1304 may include means for performing the at least one measurement based on the aperiodic gap. In some aspects, the apparatus 1304 may include means for based on a result of the at least one measurement, transmitting a second UAI including a second request for a fourth value of the gap periodicity. The means may be the component 198 of the apparatus 1304 configured to perform the functions recited by the means. As described supra, the apparatus 1304 may include the TX processor 368, the RX processor 356, and the controller/processor 359. As such, in one configuration, the means may be the TX processor 368, the RX processor 356, and/or the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method for wireless communication at a user equipment (UE), including: receiving, from a network entity, a configuration of at least one measurement associated with a gap length, a gap periodicity, and a gap offset; transmitting, to the network entity, UE assistance information (UAI) including a request for a first value for the gap length, a second value for the gap periodicity, or a third value for the gap offset; receiving, from the network entity, an indication associated with the first value for the gap length, the second value for the gap periodicity, or the third value for the gap offset; and performing the at least one measurement.

Aspect 2 is the method of aspect 1, where the configuration of the at least one measurement includes a fourth value for the gap length, a fifth value for the gap periodicity, or a sixth value for the gap offset, where the first value is different from the fourth value, the second value is different from the fifth value, and the third value is different from the sixth value.

Aspect 3 is the method of any of aspects 1-2, where at least one of the first value, the second value, or the third value is based on a mobility condition or a channel condition of the UE.

Aspect 4 is the method of any of aspects 1-3, where the indication provides the first value for the gap length, the second value for the gap periodicity, or the third value for the gap offset, or indicates an approval of the request, and performing the at least one measurement further includes: performing the at least one measurement based on the first value for the gap length, the second value for the gap periodicity, or the third value for the gap offset.

Aspect 5 is the method of aspect 4, further including: transmitting, to the network entity, a second UAI to disable the first value for the gap length, the second value for the gap periodicity, or the third value for the gap offset; and refraining from performing at least one additional measurement based on the first value for the gap length, the second value for the gap periodicity, or the third value for the gap offset.

Aspect 6 is the method of aspect 5, further including: transmitting, to the network entity, a third UAI to enable the first value for the gap length, the second value for the gap periodicity, or the third value for the gap offset; and performing at least one second additional measurement based on the first value for the gap length, the second value for the gap periodicity, or the third value for the gap offset.

Aspect 7 is the method of any of aspects 5-6, further including: transmitting, to the network entity, a third UAI including a second request for a fourth value for the gap length, a fifth value for the gap periodicity, or a sixth value for the gap offset.

Aspect 8 is the method of any of aspects 1-7, where the indication does not provide the first value for the gap length, the second value for the gap periodicity, or the third value for the gap offset, or indicates a denial of the request, and where performing the at least one measurement further includes: performing the at least one measurement based on a fourth value for the gap length, a fifth value for the gap periodicity, or a sixth value for the gap offset, where the first value is different from the fourth value, the second value is different from the fifth value, and the third value is different from the sixth value.

Aspect 9 is the method of any of aspects 1-8, further including: starting a timer upon a transmission of the UAI; and based on lack of reception of the first value for the gap length, the second value for the gap periodicity, or the third value for the gap offset in the indication before the timer expires, performing the at least one measurement based on one or more virtual gaps.

Aspect 10 is the method of aspect 9, further including: opening the one or more virtual gaps by setting a channel quality indicator (CQI) as zero; and transmitting an indication of a capability associated with the one or more virtual gaps.

Aspect 11 is the method of aspect 1, where the request is for an aperiodic gap and the UAI does not include the second value for the gap periodicity, and where the UAI further includes a starting position associated with the aperiodic gap.

Aspect 12 is the method of aspect 11, further including: performing the at least one measurement based on the aperiodic gap; and based on a result of the at least one measurement, transmitting a second UAI including a second request for a fourth value of the gap periodicity.

Aspect 13 is the method of any of aspects 11-12, where the request is for the aperiodic gap is based on a change of a mobility state, a channel condition, or a signal condition of the UE.

Aspect 14 is the method of any of aspects 11-13, where the request is based on a performance of a terrestrial network (TN) coverage condition associated with the UE being below a threshold in a presence of non-terrestrial network (NTN) coverage.

Aspect 15 is the method of any of aspects 11-14, further including: prior to a reception of the configuration, transmitting, to the network entity, a request for at least one measurement gap.

Aspect 16 is an apparatus for wireless communication at a wireless device including at least one memory and at least one processor coupled to the at least one memory and, based at least in part on information stored in the at least one memory, the at least one processor is configured, individually or in combination, to implement any of aspects 1 to 15.

Aspect 17 is the apparatus of aspect 16, further including one or more transceivers or one or more antennas coupled to the at least one processor.

Aspect 18 is an apparatus for wireless communication at a wireless device including means for implementing any of aspects 1 to 15.

Aspect 19 is a computer-readable medium (e.g., a non-transitory computer-readable medium) storing computer executable code, where the code when executed by at least one processor causes the at least one processor to implement any of aspects 1 to 15.

What is claimed is:

1. An apparatus for wireless communication at a user equipment (UE), comprising:
at least one memory; and
at least one processor coupled to the at least one memory and, based at least in part on stored information that is stored in the at least one memory, the at least one processor, individually or in any combination, is configured to cause the UE to:
receive, from a network entity, a configuration of at least one measurement associated with a gap length, a gap periodicity, and a gap offset;
transmit, to the network entity, UE assistance information (UAI) comprising a request for a first value for the gap length, a second value for the gap periodicity, or a third value for the gap offset;
receive, from the network entity, an indication associated with the first value for the gap length, the second value for the gap periodicity, or the third value for the gap offset; and
perform the at least one measurement.

2. The apparatus of claim 1, wherein the configuration of the at least one measurement comprises a fourth value for the gap length, a fifth value for the gap periodicity, or a sixth value for the gap offset, wherein the first value is different from the fourth value, the second value is different from the fifth value, and the third value is different from the sixth value.

3. The apparatus of claim 1, wherein at least one of the first value, the second value, or the third value is based on a mobility condition or a channel condition of the UE.

4. The apparatus of claim 1, wherein the indication provides the first value for the gap length, the second value for the gap periodicity, or the third value for the gap offset, or indicates an approval of the request, and wherein to perform the at least one measurement, the at least one processor, individually or in any combination, is configured to cause the UE to:
perform the at least one measurement based on the first value for the gap length, the second value for the gap periodicity, or the third value for the gap offset.

5. The apparatus of claim 4, wherein the at least one processor, individually or in any combination, is further configured to cause the UE to:
transmit, to the network entity, a second UAI to disable the first value for the gap length, the second value for the gap periodicity, or the third value for the gap offset; and
refrain from performing at least one additional measurement based on the first value for the gap length, the second value for the gap periodicity, or the third value for the gap offset.

6. The apparatus of claim 5, wherein the at least one processor, individually or in any combination, is further configured to cause the UE to:
transmit, to the network entity, a third UAI to enable the first value for the gap length, the second value for the gap periodicity, or the third value for the gap offset; and
perform at least one second additional measurement based on the first value for the gap length, the second value for the gap periodicity, or the third value for the gap offset.

7. The apparatus of claim 5, wherein the at least one processor, individually or in any combination, is further configured to cause the UE to:
transmit, to the network entity, a third UAI comprising a second request for a fourth value for the gap length, a fifth value for the gap periodicity, or a sixth value for the gap offset.

8. The apparatus of claim 1, wherein the indication does not provide the first value for the gap length, the second value for the gap periodicity, or the third value for the gap offset, or indicates a denial of the request, and wherein to perform the at least one measurement, the at least one processor, individually or in any combination, is configured to cause the UE to:
perform the at least one measurement based on a fourth value for the gap length, a fifth value for the gap periodicity, or a sixth value for the gap offset, wherein the first value is different from the fourth value, the second value is different from the fifth value, and the third value is different from the sixth value.

9. The apparatus of claim 1, wherein the at least one processor, individually or in any combination, is further configured to cause the UE to:
start a timer upon a transmission of the UAI; and
based on lack of reception of the first value for the gap length, the second value for the gap periodicity, or the third value for the gap offset in the indication before the timer expires, perform the at least one measurement based on one or more virtual gaps.

10. The apparatus of claim 9, wherein the at least one processor, individually or in any combination, is further configured to cause the UE to:
open the one or more virtual gaps by setting a channel quality indicator (CQI) as zero; and
transmit an indication of a capability associated with the one or more virtual gaps.

11. The apparatus of claim 1, wherein the request is for an aperiodic gap and the UAI does not include the second value for the gap periodicity, and wherein the UAI further comprises a starting position associated with the aperiodic gap.

12. The apparatus of claim 11, wherein the at least one processor, individually or in any combination, is further configured to cause the UE to:
perform the at least one measurement based on the aperiodic gap; and
based on a result of the at least one measurement, transmit a second UAI comprising a second request for a fourth value of the gap periodicity.

13. The apparatus of claim 11, wherein the request is for the aperiodic gap is based on a change of a mobility state, a channel condition, or a signal condition of the UE.

14. The apparatus of claim 11, wherein the request is based on a performance of a terrestrial network (TN) coverage condition associated with the UE being below a threshold in a presence of non-terrestrial network (NTN) coverage.

15. The apparatus of claim 11, wherein the at least one processor, individually or in any combination, is further configured to cause the UE to:
prior to a reception of the configuration, transmit, to the network entity, a request for at least one measurement gap.

16. A method for wireless communication performed by a user equipment (UE), comprising:
receiving, from a network entity, a configuration of at least one measurement associated with a gap length, a gap periodicity, and a gap offset;
transmitting, to the network entity, UE assistance information (UAI) comprising a request for a first value for the gap length, a second value for the gap periodicity, or a third value for the gap offset;
receiving, from the network entity, an indication associated with the first value for the gap length, the second value for the gap periodicity, or the third value for the gap offset; and
performing the at least one measurement.

17. The method of claim 16, wherein the configuration of the at least one measurement comprises a fourth value for the gap length, a fifth value for the gap periodicity, or a sixth value for the gap offset, wherein the first value is different from the fourth value, the second value is different from the fifth value, and the third value is different from the sixth value.

18. The method of claim 16, wherein at least one of the first value, the second value, or the third value is based on a mobility condition or a channel condition of the UE.

19. An apparatus for wireless communication performed by a user equipment (UE), comprising:
means for receiving, from a network entity, a configuration of at least one measurement associated with a gap length, a gap periodicity, and a gap offset;
means for transmitting, to the network entity, UE assistance information (UAI) comprising a request for a first value for the gap length, a second value for the gap periodicity, or a third value for the gap offset;
means for receiving, from the network entity, an indication associated with the first value for the gap length, the second value for the gap periodicity, or the third value for the gap offset; and
means for performing the at least one measurement.

20. The apparatus of claim 19, wherein at least one of the first value, the second value, or the third value is based on a mobility condition or a channel condition of the UE.
